(19) United States
(12) Patent Application Publication
(10) Pub. No.: US 2016/0132930 A1
(43) Pub. Date: May 12, 2016

(54) Mobile Device Proximity Determination

(71) Applicants: Brian Handly, Raleigh, NC (US); Jared Dean, Raleigh, NC (US); Matthew Davis, Raleigh, NC (US); Todd Moses, Raleigh, NC (US)

(72) Inventors: Brian Handly, Raleigh, NC (US); Jared Dean, Raleigh, NC (US); Matthew Davis, Raleigh, NC (US); Todd Moses, Raleigh, NC (US)

(21) Appl. No.: 14/931,647

(22) Filed: Nov. 3, 2015

Related U.S. Application Data
(60) Provisional application No. 62/077,655, filed on Nov. 10, 2014.

(51) Int. Cl. G06Q 30/02; H04W 4/04; H04W 4/00; H04W 4/02

(52) U.S. Cl. CPC G06Q 30/0261; H04W 4/023; H04W 4/043; H04W 4/008; G06Q 30/0267; G06Q 30/0269

(57) ABSTRACT

The present invention is a method and system of locating mobile devices and building a database of the mobile device locations through the interaction of mobile devices with one or more proximity activation systems. The method and system uses beacon proximity activity to refine the location of a beacon and the relative position of one or more mobile devices to the beacon through a trilateration or multiple activation point distance calculation. As mobile devices come within a pre-determined proximity to a beacon, applications installed on the mobile devices supply a location and identity of the mobile device at the time of activation. The system and method may assign personas to the mobile device. The system and method uses numerous activations to refine and report the physical location of the beacon.

### CLAIM TO PRIORITY

This Non-Provisional application claims under 35 U.S.C. § 120, the benefit of the Provisional Application 62/077,655, filed Nov. 10, 2014, Titled “Location Determination Using Beacon Analytics”, and Provisional Application 62/110,671, filed Feb. 2, 2015, Titled “Mobile Device Proximity Determination”, each of which is hereby incorporated by reference in its entirety.

### COPYRIGHT AND TRADEMARK NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever. Trademarks are the property of their respective owners.

### BACKGROUND

A beacon is one implementation of an indoor proximity activation system that enables a smart phone or other Bluetooth enabled device to perform actions when in close proximity to a beacon receiver/transmitter.

One application is to help smart phones determine their precise position or context, With the help of a beacon, a smartphone's software can pinpoint its own location within a store, Beacons can help a phone show notifications of items nearby that are on sale, and it can enable payments at the point of sale (POS) where customers don't need to remove their wallets or cards to make payments. Beacon technology works using the Bluetooth Low Energy (BLE) technology, also known as Bluetooth Smart.

Mobile location data used to locate the physical position of an indoor proximity activation system, such as a beacon, when outside of the BLE range of the beacon is based upon latitude and longitude data. This data is highly inaccurate, having an approximate accuracy for location of a beacon of 100 meters about one-third of the time. As a result, a determination of the location of a beacon when not within the range of a beacon BLE transmission is correspondingly inaccurate. However, if beacon location were determinable with greater accuracy, metric and analytic information could be derived from interactions with the beacon having greater relevancy to mobile devices.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 is a system diagram for an exemplary system operation consistent with certain embodiments of the present invention.

FIG. 2 is a view of the process of locating a typical beacon consistent with certain embodiments of the present invention.

FIG. 3 is a process flow for the delivery of information to a mobile device located near a located beacon consistent with certain embodiments of the present invention.

FIG. 4 is a representative view of point distance vectors for activation points consistent with certain embodiments of the present invention.

FIG. 5 is a representative view of establishing a confidence band for activation points consistent with certain embodiments of the present invention.

FIG. 6 is a representative view of the selection of a representative activation point for physical location with outlier points removed consistent with certain embodiments of the present invention.

FIG. 7 is a process flow for the interaction of a mobile device with proximity activation system associated analytic data consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one, or more than one. The term “plurality”, as used herein, is defined as two, or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to one embodiment“, “certain embodiments”, an exemplary embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

Reference throughout this document to trilateration refers to the mathematical process of determining absolute or relative locations of points by measurement of distances, using the geometry of circles, spheres, or triangles. In addition to its interest as a geometric problem, trilateration does have practical applications in surveying and navigation, including global positioning systems (GPS).

Reference throughout this document to multipoint trilateration refers to the mathematical process of determining absolute or relative locations of points by measurement of distances, using the geometry of circles, spheres, or triangles. In the multipoint trilateration, all points associated with a Bluetooth Low Energy (BLE) signal are considered simultaneously, permitting lower overall computational costs.

Reference throughout this document to a beacon refers to a low energy Bluetooth (BLE) device operating as an indoor proximity activation system that transmits packets of data that allow smart devices (such as phones, tablets, computers, handheld devices, game devices, etc.) to be informed when they are in range, and where smart devices are capable of calculating their proximity to the beacon.

Mobile location data based solely on latitude and longitude is highly inaccurate. The accepted precision is that one third of the time the device will be within 100 meters of the recorded coordinates. However, the level of accuracy that is useful for mapping a location for driving directions is simply inadequate for the delivery of information to a mobile device that may be located inside a store or other public location. There is a need to provide more precise location data for mobile devices for certain applications than is provided by latitude and longitude measurements alone.

Mobile applications do not utilize cookies and for this reason the website advertising model, which relies heavily upon cookie tracking, does not work for mobile advertising. In common practice, cookies track the locations a user visits across the web through the mechanism of placing a small tracking file, or cookie, within a user's computer system. These cookies are usable by the application or web page that placed it within the cookie folder on the user computer file system. In a non-limiting example, because cookies can't track digital locations in mobile devices, we can use physical location like latitude and longitude coordinates or activation by a proximity activation system as a replacement for the cookie mechanism recited herein to “cookie” where someone visits in the real world.

In a non-limiting example, the proximity activation system may be a Beacon, and the detection of the Beacon's signal by a mobile device is known as a Beacon bump. In this example, a more accurate location determination system utilizing Beacon bumps provides a proxy for cookies based on physical location. When a mobile device detects a Beacon's signal, an application on the mobile device uses the Received Signal Strength Indication (RSSI), which is compared against a pre-set distance to signal strength ratio, to determine proximity to the Beacon as well as the accuracy of its estimation of proximity. The stronger the signal, the more confident the mobile device can be about the proximity of the Beacon. However, utilizing the signal strength of a single beacon as a measure of proximity to a mobile device can be seriously affected by the battery strength in the beacon, or other factors that affect operation of the beacon and strength of the received signal. A more accurate method for determining the location of a mobile device, with high confidence, requires utilizing all of the beacons within range of a mobile device to smooth out any inaccuracy based on a single beacon RSSI.

The location determination system creates a mobile location database built from the information supplied by proximity activation systems, such as Beacons, and other location data points. The location determination system builds an initial data set and will be increasing the data set with a Software Development Kit (SDK) and a public Application Programming Interface (API) to be included in, or integrated with, a number of widely distributed mobile applications.

In an exemplary embodiment, as more mobile devices come within proximity of a particular beacon, the system hones in on an exact beacon location through the process of trilateration of a pre-determined number of beacon activations from mobile devices. The trilateration process selects groups of three beacon activations and uses a trilateration calculation to attempt to locate an intersection point for the areas defined by the signal strength of each beacon activation as well as other location data points. An experiment was created to assist in the refinement of the location of a beacon based upon activations of one or more beacons as a series of smart mobile devices moved within the proximity of these beacons. In this experiment, a grid of beacons, each with a unique identifier, was created with known GPS coordinates, and known vectors, composed of direction and distance, from one beacon to another. As multiple mobile devices moved into the range of the grid of beacons, the trilateration algorithm was used to attempt to determine a GPS position for each beacon from the interaction with the mobile device. The determined GPS position was compared with the known physical mobile device location within the grid of beacons and the resulting difference noted. The precise physical location of a beacon (within about 10 meters) and the confidence in the data for that measurement became better known as more and more mobile device activations, known as “bumps”, were captured.

In a non-limiting example, the result of the process of locating a beacon through trilateration for a series of bumps provided confidence that the position of a beacon could be refined to the point that the physical location of the beacon could be determined to within 10 meters and increased the confidence in the accuracy of the location regardless of RSSI values. This increase in accuracy represents an increase of an order of magnitude of precision over using only the GPS location of the device. This provides significantly more accurate location, permitting the system to verify a user's location with a high degree of accuracy at specific times during the day with a high degree of confidence in the physical location. Additionally, the operating systems of smart devices permit the mobile location data to be collected from beacons through mobile applications that are not running at the time they come into range of the beacon. Data collected by a smart device when the mobile applications are not running is reported to the Reveal™ application server.

In an alternative embodiment, the location determination system may utilize a multipoint trilateration calculation to significantly improve the determination of the physical location of the proximity activation system, such as a Beacon, with which the mobile device is interacting over even a trilateration based system. In the multipoint trilateration determination, all points associated with a BLE signal are considered simultaneously, which allows for lower overall computational costs.

The activation data points are then sorted by their average distance from all other data points in the dataset. The points with the lowest average distance are closer to most other points and therefore considered to be a better approximation of the actual location of the BLE signal. A confidence band, which is the threshold to remove outlier data points, is then applied to the selected points.

With the outliers removed, Kernel Density Estimation is performed. The output of the KDE is a singular point of maximum density which is the single best estimate of the true location of the BLE signal.

In an exemplary embodiment, data is collected by the Reveal' SDK or API installed on each mobile device associated with an activation point for the proximity activation system. In a non-limiting example, the activation points are represented by beacon bumps associated with one or more beacons. The data values in the following tables are representative of the data returned to a mobile location database on a Reveal™ application server for a beacon. In other exemplary embodiments, the proximity activation system may return data values particular to the proximity activation system employed.

In this exemplary embodiment, the Reveal' application server may collect data about the smart device and may include the access level for the application, such as client, and a Uniform Resource Locator (URL). This data may also include:

| Parameter Name | Definition |
|---|---|
| device_id | This is the unique identifier assigned to |
| | the device by the operating system of |
| | the device. |
| Idfa | This is a unique identifier required by |
| | Apple and Google for delivering |
| | advertisements to the device. |
| ap_installs | Other applications installed on the |
| | device. |
| Os | The operating system of the phone, |
| | either iOS or Android. |
| Version | Which version of the operating system |
| | the device runs, such as iOS 8.1 or |
| | Android 4.4.2 |
| Locale | The chosen language setting of the |
| | device, such as English or Spanish. |
| bluetooth_version | Indicates which version of Bluetooth |
| | the device is running. |
| bluetooth_enabled | Indicates if the user’s blue tooth |
| | capabilities are enabled. |
| supports_ble | Indicates whether or not the device |
| | supports Bluetooth Low Energy (BLE). |
| app_version | Indicates the version of the app in |
| | which the Reveal SDK is running. |
| location | Time is in milliseconds: |
| | {lat: xx.xxxxx, |
| | lon: yy.yyyyy, |
| | time: zzzz } |

Additionally, in an exemplary embodiment, event data may be collected that may consist of specific information captured about each beacon bump, when the proximity activation system is composed of one or more beacons. This data is returned to the mobile location database by the Reveal' SDK or API on a Reveal' application server and may include the access level for the application, such as client, and a Uniform Resource Locator (URL). This data may also include:

| Parameter Name | Notes |
|---|---|
| characteristics | Contains the characteristics of the |
| | beacon that triggered the event. |
| bluetooth_enabled | Indicates if the user’s blue tooth |
| | capabilities are enabled |
| device_id | This is the unique identifier assigned to |
| | the device by the operating system of |
| | the device. |
| Idfa | This is a unique identifier required by |
| | Apple and Google for delivering |
| | advertisements to the device. |
| location | Time is in milliseconds: |
| | {lat: xx.xxxxx, |
| | lon: yy.yyyyy, |
| | time: zzzz } |
| beacon_uuid | A 16 byte identifier, typically |
| | represented by hexadecimal digitals. |
| | One of three identifiers used to identify |
| | a unique beacon. |
| beacon_major | An integer between 0 and 65535, used |
| | to group a set of beacons together. The |
| | second of three identifiers used to |
| | identify a unique beacon. |
| beacon_minor | An integer between 0 and 65535, used |
| | to identify a particular beacon within a |
| | major group. The third of three |
| | identifiers used to identify a unique |
| | beacon. |
| beacon_mac | The MAC address for the beacon. |
| beacon_proximity | Currently, “unknown”, “immediate”, |
| | “near”, “far” |
| beacon_accuracy | Indicates the accuracy of the proximity |
| | value, measured in horizontal meters |
| | from the beacon. |
| beacon_rssi | Indicates the “received signal strength |
| | indicator” of the beacon, or how strong |
| | the detected signal is. |
| app_version | Indicates the version of the app in |
| | which the Reveal SDK is running. |
| address | { |
| | “street”; “1234 any street”, |
| | “city”; “any city”, |
| | “state”; “any state”, |
| | “zip”; “99999”, |
| | “country”; “United States” |
| | } |

In an exemplary embodiment, utilizing trilateration, upon ascertaining the physical location of the beacon, with an accuracy of approximately 10 meters or less, the application server contacts a location database to determine the type of location in which the detected beacon is installed. In a non-limiting example, the application server may contact Google Places Application Programming Interface (API) to determine the type of location. This location type information is then stored in the database table of geographic information. If there is no place type in the Google Places API for the location identified, additional location information may be sought at other location sites that are publicly available to attempt to determine the place type. In a non-limiting example, the application server may receive information back from the Google Places API that the beacon identified at the discovered location is installed in a café.

In an alternative exemplary embodiment, utilizing the multipoint distance calculation, the physical location of the indoor proximity activation system, as represented by a Beacon, may be determined with an accuracy of approximately 10 meters or less, with the calculation proceeding more quickly than a calculation performed by strict trilateration computation. Upon determining the physical location the application server contacts a location database to determine the type of location in which the detected Beacon is installed. The application server may then contact a geographic or physical place application to determine the type of location associated with the physical location of the Beacon. In a non-limiting example, the application server may contact Google Places Application Programming Interface (API) as one example of a geographic location application. The location type information is then stored in the database table of geographic information. If there is no place type in the Google Places API for the location identified, additional location information may be sought at other location sites that are publicly available to attempt to determine the place type. In a non-limiting example, the application server may receive information back from the Google Places API that the beacon identified at the discovered location is installed in a café.

Regardless of the method of identification of location, with this identification, the application server may then build one or more classifications for the beacon at that specific location. In the non-limiting example where the beacon is identified as being installed in a café, the application server may map a café to a classification of Food&Drink >café, which then has the capability to personify any smart device that comes into contact with that classified beacon as a coffee drinker. It should be noted that a beacon may have more than one classification identified with that beacon based upon inferences for the types of retail or other activity that is associated with the place type.

The application server may create a database of classifications for each identified beacon. The classifications may be classified as to the desired relevance, or value, of the persona to the location for purposes of delivering advertising or other information to mobile devices that are, or were recently, in range of the beacon. In a non-limiting example, a desirable relevance would be a mobile device classified as having a history of purchasing goods or services an advertiser provides to buyers. It would be a waste of time to present an advertisement for fishing lures to mobile devices that come within range of a beacon installed in a café. However, it could be highly effective to present a coupon for a special promotion on coffee drinks to mobile devices classified as coffee drinkers that have come within range of that same beacon. The application server may collect click information for all ads or other informational messages that are presented to mobile devices. This information permits the application server to provide metrics on the click-through of such ads by mobile devices both outside and within range of the beacon. Click-through data, and other metric data, may be used in analyses to show the effectiveness of various types of ads and messages presented by beacons based upon their physical location and location type, providing a new range of analytic information for mobile devices that are within range of the identified beacon.

Attributing a mobile advertising spend to in-store foot traffic is impossible without highly accurate physical location data for a mobile device. Beacon recognition can address the need for creating highly accurate physical location identification of mobile devices. The application server may create a global database of precise beacon locations, which enables two distinct forms of highly targeted advertising capabilities. With a highly accurate physical location for each mobile device, mobile advertising can be directed to particular mobile devices within proximity of a beacon that is most readily associated with the focus of the mobile ad. The application server can provide highly accurate feedback on ads and information delivered a result of proximity to a particular beacon by tracking click through data from all mobile devices in range of the beacon. Additionally, the personified mobile devices may be used to build mobile audience categories that a publisher can leverage to sell targeted ads that garner high CPMs.

In an embodiment, demographic information may be combined with collected data from smart mobile devices. This information may include gender, income range, education level, age range, and additional demographic information available from public sources. The public sources consulted may include, but are not limited to, US Bureau of the Census, automotive data, TV viewing data, purchase data, and grocery store shopping data. The demographic data may provide the creation of new personas or may strengthen existing personas, enhancing the targeting and placement of advertising and informational messages and communications. Personas may be created to be associated by gender, income range, education level, age range, automotive data, TV viewing data, purchase data, and grocery store shopping data, as well as any other data point associated with commercial activity that involves the possessor of a mobile device.

In an embodiment, the Reveal™ application server may integrate with a plurality of advertising servers. This direct communication pathway will permit tracking and management of every advertising and informational message delivered to every device within the sphere of the advertising server. The direct integration with advertising servers may strengthen attribution reporting and permit stronger correlations between delivered messages and mobile devices. This data may be collected in one or more Reveal™ and/or advertising server databases and managed by one or more Reveal™ analytics management processes.

In an embodiment, the Reveal™ application server may evaluate latitude and longitude data provided by a GPS process associated with each mobile device on which a Reveal™ enabled application is installed. This data is provided upon the startup of the application. The data may be analyzed and utilized to build known locations, such as home, work, and other locations for the mobile device, and additional persona information based upon location history. This information will be stored upon and managed by one or more Reveal™ application servers.

In an additional embodiment, a Reveal™ application server may utilize metrics and other collected data to evaluate all known locations, personas, and historical behaviors to create analytics for all mobile devices known to the system. This analytic information may be used to create predictive advertising for the mobile devices. In this process, advertising data may be targeted for delivery to a mobile device based upon predictions of future intent for each mobile device and personas associated with mobile devices.

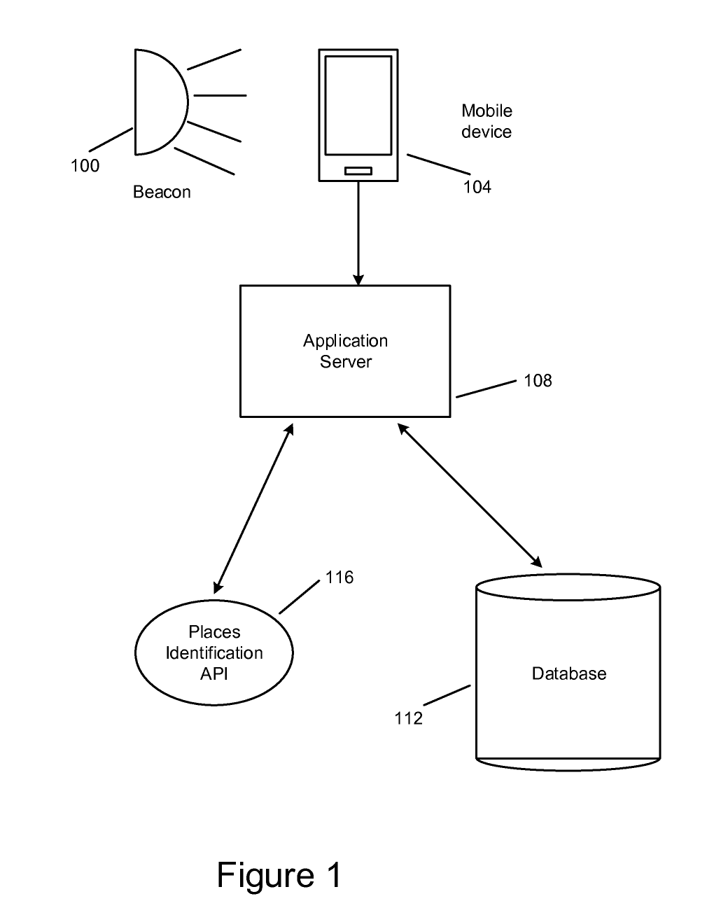

Turning now to FIG. 1, this figure presents a system diagram for an exemplary system operation consistent with certain embodiments of the present invention. An indoor proximity activation system 100, such as a beacon, may be installed within physical locations such as stores, sporting areas, malls, parks, cafes and restaurants, or any other physical location where information may be transmitted to a mobile device 104. A beacon bump is an activation indication from the indoor proximity activation system 100 that is transmitted to the application server 108 when a mobile device upon which the Reveal™ SDK has been installed. When a beacon bump is detected, the beacon information, containing at least the uuid, major, minor, and name fields, is transmitted to the Reveal™ application server 108. The application server 108 stores the transmitted beacon information in a relational database 112 on the application server 108, either as a new entry into a beacon data table or as an update to an entry already stored in the beacon data table. The application server 108 also adds geographical data, the latitude and longitude, for the beacon into a data table. Additionally data regarding the mobile device manufacturer, operating system type and other metrics are stored in a separate data table on the application server 108.

After the application server 108 has completed a refinement calculation for the geographical location of the indoor proximity activation system 100, the application server 108 may seek to identify the location in which the indoor proximity activation system 100 has been installed. In a non-limiting example, the application server 108 may contact a places identification service 116, such as Google Places, through the API and present the physical location information to check the type of place in which the indoor proximity activation system 100 is operating. Once the type of place is returned from the places identification API 116, this information is stored in the relational database 112 and associated with that particular beacon.

Upon the conclusion of this operation, the Reveal™ system has a table of beacon information and associated data regarding the number of mobile device activations near the indoor proximity activation system 100, the type of place in which the indoor proximity activation system 100 is installed, and the precise physical location of the indoor proximity activation system 100 within that location.

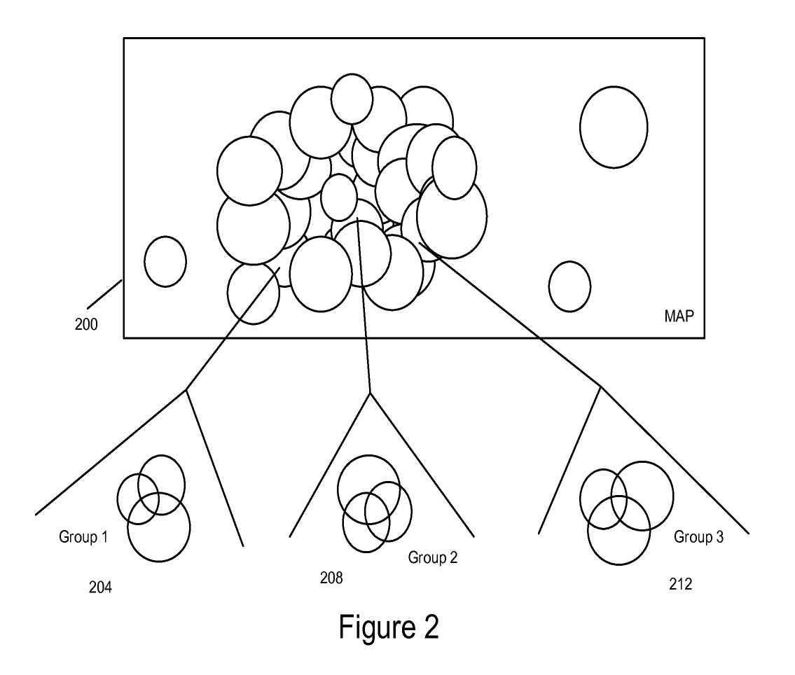

Turning to FIG. 2, this figure presents a view of the process of locating a typical beacon consistent with certain embodiments of the present invention. After a pre-set number of bumps for a beacon have been collected, where, in a non-limiting example the number of bumps may be set to an exemplary number such as 30, a calculation is performed within the application server to refine the geographical location of the beacon. The accuracy of the geographical location of a beacon is based upon the latitude and longitude of the beacon and the proximity of the mobile device to the beacon. However, the accuracy of the estimation of proximity, and the determination of proximity itself, are highly dependent upon the distance from the beacon to the mobile device, whether the beacon is inside or outside of a physical structure, whether the mobile device is in a location such as a backpack, purse, or pocket, and what obstructions might be between the mobile device and the beacon, including the physical body of the person holding the mobile device. For these reasons, a precise location for a beacon in relation to a mobile device and the confidence in the accuracy of the relative position of the beacon to the mobile device may be highly inaccurate.

The application server, therefore, may use a trilateration in a series of calculations to refine the precise location of the beacon, based upon the pre-set number of beacon bumps transmitted to the application server for that beacon. As seen on the map 200, each beacon bump is represented by an activation area in which the activation area is a circle with the mobile device at the center and the diameter of the circle directly proportional to the received signal strength from the mobile device. The trilateration calculation requires the use of three points and this area around each point that is directly proportional to the received signal strength from the mobile device to find an intersection point for all three areas, which is presumably a more accurate location of the beacon.

The application server first selects a group of three points, such as the points represented by Group 1 204. The trilateration calculation is a well-known mathematical construct for determining the intersection of three circles or spheres from the center point and radii of the circles or spheres and will not be further described herein. However, the application server may perform the calculation on the beacon bumps represented by the three circles of Group 1 to determine the intersection point, which may be inferred to be an improvement upon the accuracy of location of the beacon. The application server may then select the next three points, as represented by Group 2 208, and perform the same calculation to determine the intersection of these three areas. The application server may select the next three points, as represented by Group 3 212, and continue the process of locating the intersection point for this group.

Performing this calculation repeatedly for additional groups of three points, and their associated areas based upon received signal strength, continues to refine the location accuracy of the beacon until all 30 beacon bumps have been included in the calculation and the physical accuracy of the beacon location is within at most 10 meters. This series of calculations, performed over such a large data set, has the added advantage of ignoring mobile device activation signals that are “outliers.” Outliers in this context refer to signals in which the proximity signal is highly unstable, which could indicate someone moving quickly past the beacon, for which the distance from the beacon is far outside the actual beacon power range, which could indicate just poor device performance, or for which the data is completely inconsistent with the rest of the beacon bumps for this beacon.

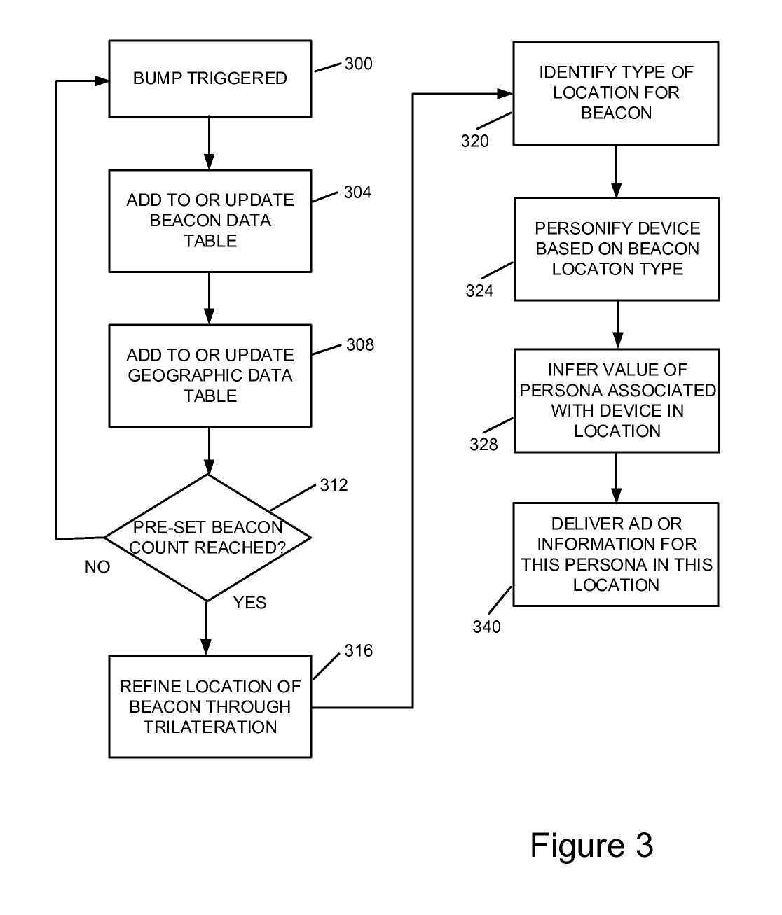

Turning now to FIG. 3, this figure presents a process flow for the delivery of information to a mobile device located near a located beacon consistent with certain embodiments of the present invention. In this exemplary embodiment, the process is activated when a mobile device enters into the signal range of a beacon, causing an activation of the beacon referred to in a non-limiting example as a “bump” 300. The beacon bump causes the application SDK installed on the mobile device to send a record of the beacon bump to the Reveal™ application server.

The record of the beacon bump contains information about the beacon (uuid, major, minor, name, and like fields). The beacon information is added to the Reveal™ database in the beacon table 304. The beacon table in the database may add an additional record for a new beacon, if this beacon has not yet been encountered, or may update an existing beacon record. Additionally, the application server may update the geographic data for the beacon by updating or adding to the BeaconClass table 308, which contains geographic data for all beacons encountered by mobile devices that have the Reveal™ SDK installed in any of a number of widely available mobile application that has been downloaded to the mobile device. The application server also updates the database with physical information about the mobile device such as manufacturer, application type installed, operating system, and similar device information.

The application server then checks the number of beacon bumps that have been received for a given beacon to determine if the number of beacon bumps is equal to or greater than a pre-set threshold 312. If the threshold has not been met, the application server may continue to collect beacon bumps 300 until that number has been met. It is to be understood that the threshold number may be any number, however, in an exemplary embodiment a pre-set number of 30 beacon bumps may be used as a reasonable number to collect prior to continuing the process for physical location optimization. If the threshold has been met, the Reveal™ application server may then begin to process the beacon location information collected with each beacon bump.

At 316, the application server uses the trilateration calculation, as described with respect to FIG. 2, to refine the location of the beacon. The application server may process the beacon bumps in groups of three to continue to refine the accuracy of the beacon location until all of the collected information has been processed. This process generally provides a physical location for the beacon that is accurate to within 10 meters. Upon deriving the physical location for the beacon, the application server then identifies the type of location in which the beacon has been installed and stores that information in the database in association with the beacon information 320.

Once the place type has been determined, the location is mapped to a classification, such as a café, sports area, store, mall, park, or the like 324. Each location may be mapped to more than one classification, and a determination may be made as to the relative value of each type of classification associated with a location 328. This information is stored into the database for later use in metrics, analytics, and the determination of service offerings. The value may be used to deliver ads or information to device personas based upon a hierarchical listing of personas 340. In a non-limiting example, a high value persona is one for which there may be active advertisers willing to pay a premium to present their ads or information to a location that has the persona type for which their goods are appropriate. Ranking the value of personas for each location permits the Reveal™ application server to deliver ads and information to high value targets on a priority basis.

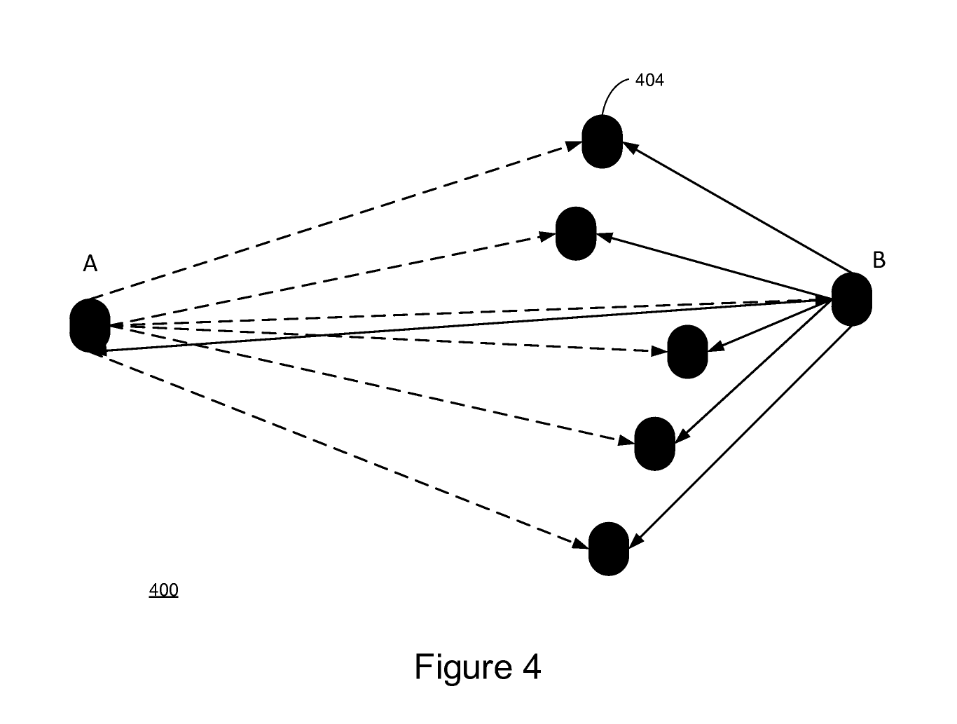

Turning to FIG. 4, this figure presents a representative view of point distance vectors for activation points consistent with certain embodiments of the present invention. After a pre-set number of activations, or bumps, have been collected by the indoor proximity activation system, a calculation is performed within the application server to refine the geographical location of the indoor proximity activation system. In this non-limiting example, the indoor proximity activation system is a beacon supplying a BLE signal. The accuracy of the geographical location of a beacon is based upon the latitude and longitude of the beacon and the proximity of the mobile device to the beacon. However, the accuracy of the estimation of proximity, and the determination of proximity itself, are highly dependent upon the distance from the beacon to the mobile device, battery strength, whether the beacon is inside or outside of a physical structure, whether the mobile device is in a location such as a backpack, purse, or pocket, and what obstructions might be between the mobile device and the beacon, including the physical body of the person holding the mobile device. For these reasons, a precise location for a beacon in relation to a mobile device and the confidence in the accuracy of the relative position of the beacon to the mobile device may be highly inaccurate.

The application server, therefore, may use a multipoint trilateration calculation to refine the precise location of the beacon, based upon the pre-set number of beacon bumps transmitted to the application server for that beacon. As seen on the map 400, each beacon bump is represented by an activation area in which the activation area is a circle with the mobile device at the center and the diameter of the circle directly proportional to the received signal strength from the mobile device. In a non-limiting example, the distance vectors for point A and point B in relation to all other activation points 404 is presented. When calculating the physical location utilizing multipoint trilateration, all points associated with a specific BLE signal that have provided latitude and longitude data are queried from the database. A distance matrix from all points to all other points delivered from the database is created. To reduce computational complexity, only the lower or upper point location needs to be created because the matrix is symmetric. This process requires a distance calculation to be performed for i²/2 points compared with the three point trilateration which is ti/kl(i−k) where i represents the number number of beacon bumps. To illustrate the savings, for 1000 points, where each point is a beacon bump, a standard three point trilateration method needs to perform over 166,000,000 calculations to complete the distance matrix compared to 500,000 for the multipoint calculation method. The computational savings increase with increasingi.

The average distance of a particular point A to all other points is calculated. Any centrality measure may be used to determine average distance for all points, such as the mean, median, or any preferred centrality measure calculation. In a non-limiting example, the mean is used because of the speed of calculation for this centrality measure, but the median, standard deviation, or some other centrality measure could be used in special applications.

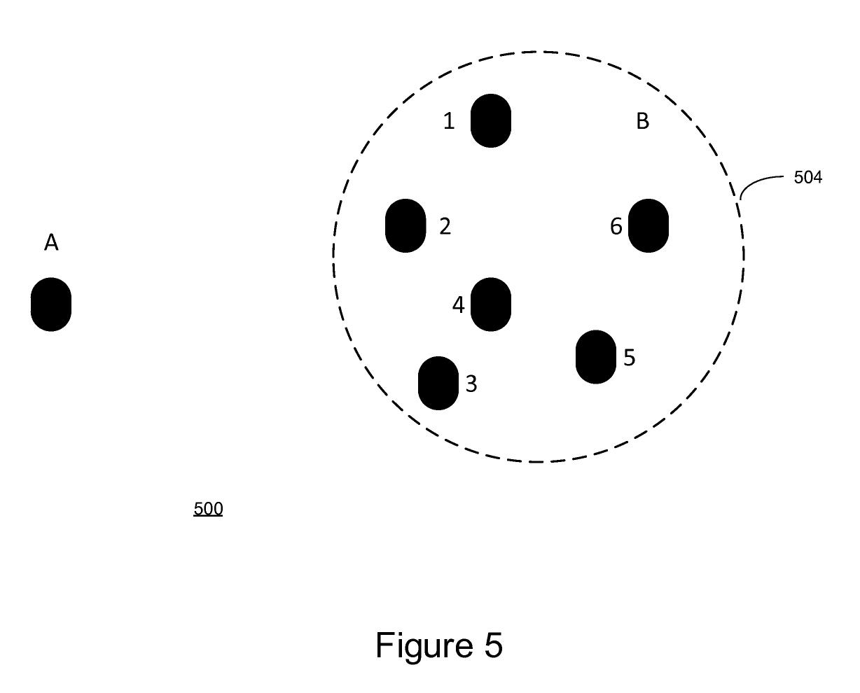

Turning to FIG. 5, this figure presents a representative view of establishing a confidence band for activation points consistent with certain embodiments of the present invention. The activation data points (1-6) are then sorted by their average distance from all other data points in the dataset. The point B with the lowest average distance is closer to most other points and therefore considered to be a better approximation of the actual location of the BLE signal. A confidence band 504, which is the threshold to remove outlier data points, is then applied to the selected points (1-6). An outlier data point A is a data point that is suspect as not being a true location data point. An outlier A may represent an artifact generated by the system or any other malfunction that nevertheless is stored as a legitimate data point but is perhaps suspect as being out of activation range, in a suspect physical position, or is in any way not representative of the data set of activation points. Any representative confidence band 504 or other process may be selected that meets the needs of the particular calculation. For example, outlier data points could also be identified based on a natural break or one-class type method. However, in an exemplary, non-limiting example, an initial implementation for the confidence band 504 of 90% was chosen as the threshold to remove outlier data points A. Note: if the bottom 10% of the data were not outliers but only the farthest points from a beacon then there would be no measurable effect in the ability to identify the true point of origin for the BLE signal. Thus, even if the 10% of data points that are outside of the confidence band were true activation data points (1-6) and not just outlier points, the location calculation is not adversely affected.

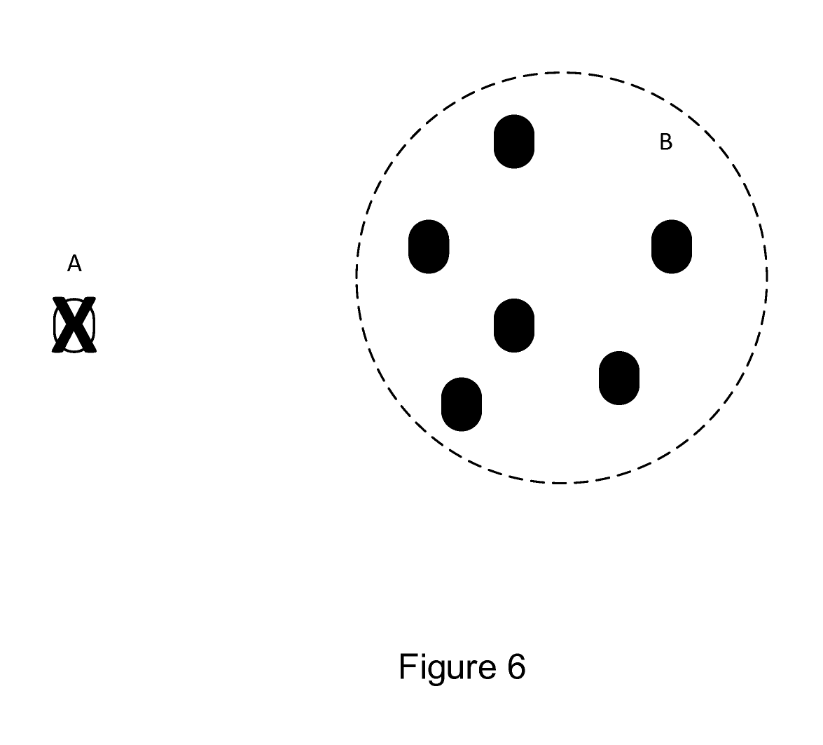

Turning to FIG. 6, this figure presents a representative view of the selection of a representative activation point for physical location with outlier points removed consistent with certain embodiments of the present invention. With the outliers A removed, Kernel Density Estimation is performed. The output of the KDE is a singular point of maximum density which is the single best estimate of the true location of the BLE signal. With the single best point and a measure of that density a determination can be made to the stationary nature of the BLE source with regard to the location of the beacon and the confidence in that position that is the BLE source B. Although a traditional three point trilateration calculation may be used to determine the stationary nature of a beacon, the advantages of this approach of trilateration over the traditional three point trilateration approach are that this method does not rely on the distance to the signal, which is sometimes missing and often has significant measurement error. Also, the amount of computation is fixed and therefore reliable for planning of the business operation.

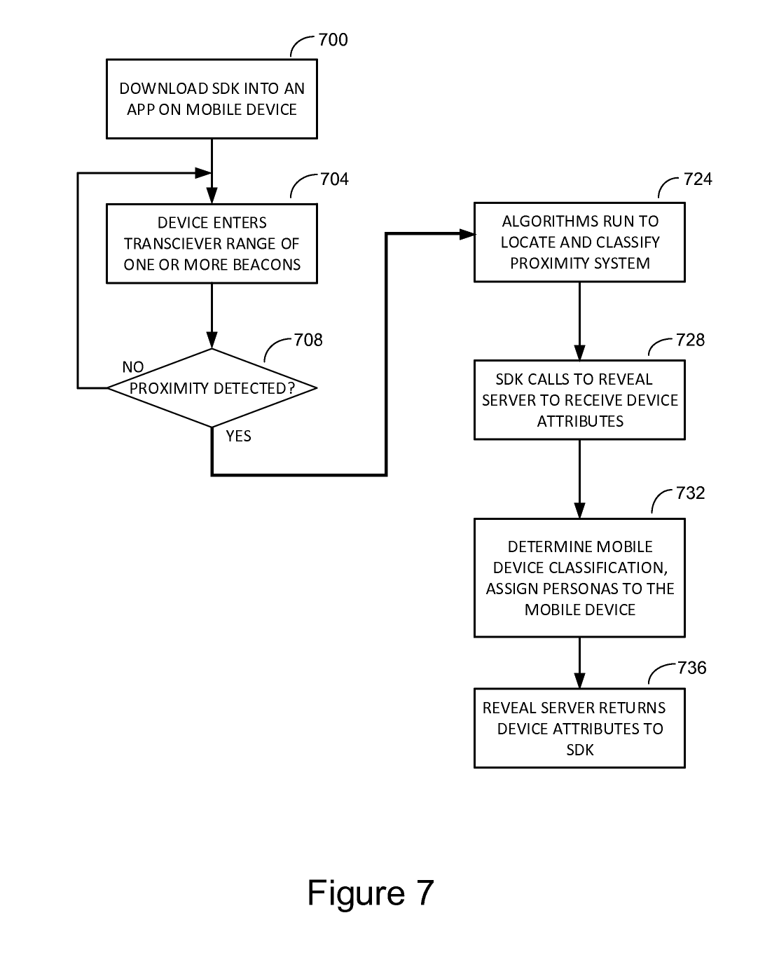

Turning now to FIG. 7, this figure presents a process flow for the delivery of information to a mobile device located near a located beacon consistent with certain embodiments of the present invention. In this exemplary embodiment, the process is activated when a mobile device that has previously downloaded the Reveal™ SDK or an API associated with the SDK 700 enters into the signal range of a proximity activation system, such as a beacon 704. If the mobile device detects the beacon 708, it causes an activation of the beacon referred to in a non-limiting example as a “bump”. If the mobile device does not detect the beacon 708, the mobile device may not have a properly installed SDK or API, the range may be too great for detection to occur, the mobile device may be moving too rapidly past the beacon for detection, or the beacon may be malfunctioning. In this occurrence, the mobile device will wait until it enters the range of another proximity activation system represented by a beacon.

Upon receipt of the information from the mobile device, the beacon information is added to the Reveal™ database in the beacon table. The record of the beacon bump contains information about the beacon (uuid, major, minor, name, and like fields). The beacon table in the database may add an additional record for a new beacon, if this beacon has not yet been encountered, or may update an existing beacon record. Additionally, the application server may update the geographic data for the beacon by updating or adding to the BeaconClass table, which contains geographic data for all beacons encountered by mobile devices that have the Reveal™ SDK installed in any of a number of widely available mobile application that has been downloaded to the mobile device. The application server also updates the database with physical information about the mobile device such as manufacturer, application type installed, operating system, and similar device information.

The application server then checks the number of beacon bumps that have been received for a given beacon to determine if the number of beacon bumps is equal to or greater than a pre-set threshold. If the threshold has not been met, the application server may continue to collect beacon bumps until that number has been met. It is to be understood that the threshold number may be any number that may be used as a reasonable number to collect prior to continuing the process for physical location optimization. If the threshold has been met, the Reveal™ application server may then begin to process the beacon location information collected with each beacon bump.

At 724, the application server uses a multipoint trilateration calculation as described previously to refine the location of the beacon, and performs additional classification operations based upon the calculated physical location. The application server process generally provides a physical location for the beacon that is accurate to within 10 meters. Upon deriving the physical location for the beacon, the application server then identifies the type of location in which the beacon has been installed and stores that information in the database in association with the beacon information.

Once the place type has been determined, the location is mapped to a classification, such as a café, sports area, store, mall, park, or the like. The SDK on the mobile device requests attributes that have been determined for the mobile device 728. The application server may determine the mobile device attributes to be assigned to the mobile device based upon physical location and information contained in the database about the mobile device. In a non-limiting example, the determination of a home zip code may be calculated for a mobile device. All startup events logged for a mobile device may be filtered to those occurring between the hours of 10 pm and 7:30 am, the hours when most individuals are in their domicile and use the multipoint trilateration calculation to provide a location of the domicile associated with that mobile device. Using this determined physical location, a zip code may be determined from publicly available US census data. In an alternative non-limiting example, the gender of the mobile device user may be ascertained with a reasonable accuracy. The application server may calculate the distance the mobile device travels each day, combine this information with the recorded beacon bumps and the types of establishments associated with each beacon bump. Using this information, as well as possible text message survey information, a determination as to gender may be made that is reasonably accurate.

Each location may be mapped to more than one classification, and a determination may be made as to the relative value of each type of classification associated with a location. This information is stored into the database for later use in metrics, analytics, and the determination of service offerings 732.

The Reveal™ server returns the requested attributes for the mobile device to the SDK associated with the mobile device 736. The mobile device attributes, such as the mobile device classification and assigned personas, may be used to deliver ads or information to device personas based upon a hierarchical listing of personas. In a non-limiting example, a high value persona is one for which there may be active advertisers willing to pay a premium to present their ads or information to a location that has the persona type for which their goods are appropriate. Ranking the value of personas for each location permits the Reveal' application server to deliver ads and information to high value targets on a priority basis.

While certain illustrative embodiments have been described, it is evident that many alternatives, modifications, permutations and variations will become apparent to those skilled in the art in light of the foregoing description.

What is claimed is:

1. A method of communication delivery to mobile devices, comprising:
capturing a plurality of mobile device activations by a proximity activation system;
determining location of the proximity activation system activated by a pre-determined number of mobile device activations;
associating the proximity activation system location with a physical address or location;
associating one or more personas with each mobile device that activated the proximity activation system; and
delivering communications targeted to one or more personas associated with each mobile device.

2. The method of claim 1, where the proximity activation system is a beacon.

3. The method of claim 1, where the determining of the location of the proximity activation system is accomplished through the analysis of a plurality of known mobile device activations.

4. The method of claim 3, where the analysis of a plurality of known mobile device activations is a trilateration calculation.

5. The method of claim 3, where the analysis of a plurality of known mobile device activations is a multipoint distance calculation.

6. The method of claim 1, where the physical address or location is identified through publicly available data records.

7. The method of claim 1, where personas created to be associated with a mobile device by gender, income range, education level, age range, automotive data, TV viewing data, purchase data, and grocery store shopping data, as well as any other data point associated with commercial activity that involves the possessor of a mobile device.

8. The method of claim 1, where delivering communications includes the delivery of advertising information to a mobile device.

9. The method of claim 8, where the advertising information delivered to a mobile device is targeted based upon one or more personas associated with the mobile device.

10. The method of claim 1, where delivering communications includes text messages, informational messages, email, alerts, specials, or any other communication that is associated with the location of the mobile device as determined by the proximity activation system.
